(19) United States
(12) Patent Application Publication
(10) Pub. No.: US 2002/0174723 A1
(43) Pub. Date: Nov. 28, 2002

(54) Detachable pressure gauge for a hand pump

(76) Inventor: Louis Chuang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/864,556

(22) Filed: May 23, 2001

(51) Int. Cl. G01L 7/00

(52) U.S. Cl. 73/700

(57) ABSTRACT

A hand pump comprises a cylinder head and a pressure gauge. The cylinder head comprises an air passage for inflating an object to be inflated. The cylinder head further comprises a receptacle communicated with the air passage. The pressure gauge is detachably engaged with the receptacle of the cylinder head. Alternatively, the pressure gauge is pivotally engaged with the receptacle of the cylinder head. A coupler may be engaged with the pressure gauge for engaging with a tire valve.

### BACKGROUND OF THE INVENTION

1. Field of the Invention

The present invention relates to a detachable pressure gauge for a hand pump and, more particularly, to a pressure gauge that can be detached from a hand pump for independent use.

2. Description of the Related Art

A conventional tire pressure gauge for hand pumps is generally secured to a hand pump and thus limited in reading orientation. More particularly, it is inconvenient to the user when the pressure gauge is located in a difficult-to-read position. In addition, the pressure gauge cannot be detached from the hand pump for independent use. The user has to carry the whole hand pump just for measuring the tire pressure.

### SUMMARY OF THE INVENTION

It is the primary object of the present invention to provide pressure gauge that can be detached from a hand pump for independent use.

In accordance with a first aspect of the invention, a hand pump comprises a cylinder head and a pressure gauge. The cylinder head comprises an air passage for inflating an object to be inflated. The cylinder head further comprises a receptacle communicated with the air passage. The pressure gauge is detachably engaged with the receptacle of the cylinder head.

In accordance with a second aspect of the invention, a hand pump comprises a cylinder head and a pressure gauge. The cylinder head comprises an air passage for inflating an object to be inflated. The cylinder head further comprises a receptacle communicated with the air passage. The pressure gauge is pivotally engaged with the receptacle of the cylinder head.

The pressure gauge comprises a main body including a pressure-sensing means therein and a tubular member formed on a side thereof. The main body further includes a display for displaying a pressure value detected by the pressure-sensing means. A seat includes a first portion securely yet detachably engaged in the receptacle of the cylinder head and a second portion received in the tubular member. The seat includes an inner passage intercommunicating the pressure-sensing means with the air passage of the cylinder head. The inner passage of the seat comprises a longitudinal hole having an end communicated with the air passage of the cylinder head and a transverse hole that intercommunicates with the pressure-sensing means with the longitudinal hole of the seat. An end plug is engaged with the second portion of the seat for sealing another end of the longitudinal hole of the seat. The receptacle comprises a shoulder portion. A tubular engaging member is securely yet releasably engaged in the shoulder portion, wherein the first portion of the seat extends through the tubular engaging member and into the receptacle.

The present invention also provides a pressure gauge that is detachably mounted to a hand pump for independent use. A coupler may be engaged with the pressure gauge for engaging with a tire valve.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a hand pump with a detachable pressure gauge in accordance with the present invention.

FIG. 2 is an exploded perspective view of the hand pump in accordance with the present invention.

FIG. 3 is a side view, partly sectioned along line A-A in FIG. 1, of the hand pump in accordance with the present invention.

FIG. 4 is an enlarged sectional view of a circle in FIG. 3.

FIGS. 5A and 5B are schematic top views of the hand pump, illustrating pivotal arrangement of the pressure gauge.

FIG. 6 is a schematic side view, in an enlarged scale, illustrating detachment of the pressure gauge.

FIG. 7 is a perspective view of the pressure gauge in accordance with the present invention.

### DETAILED DESCRIPTION OF THE PREFERRED EMBODIMENT

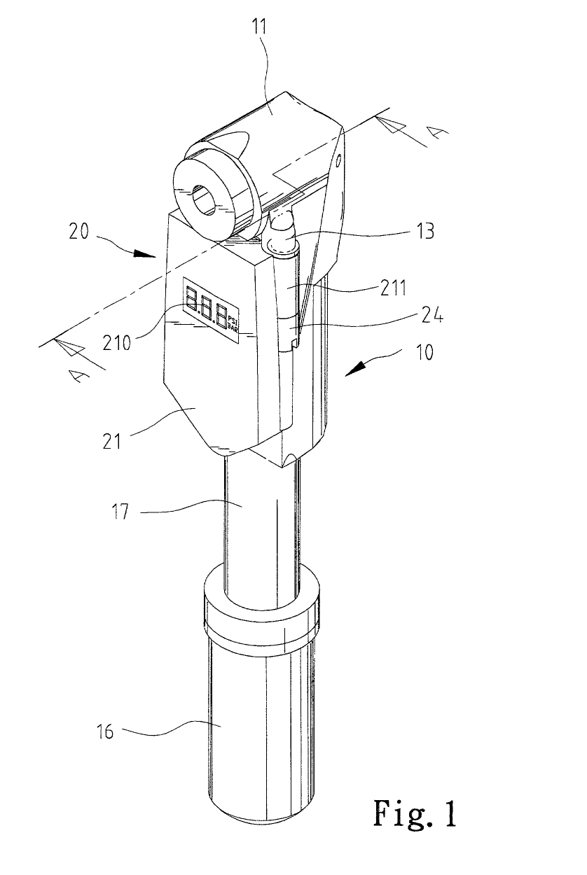

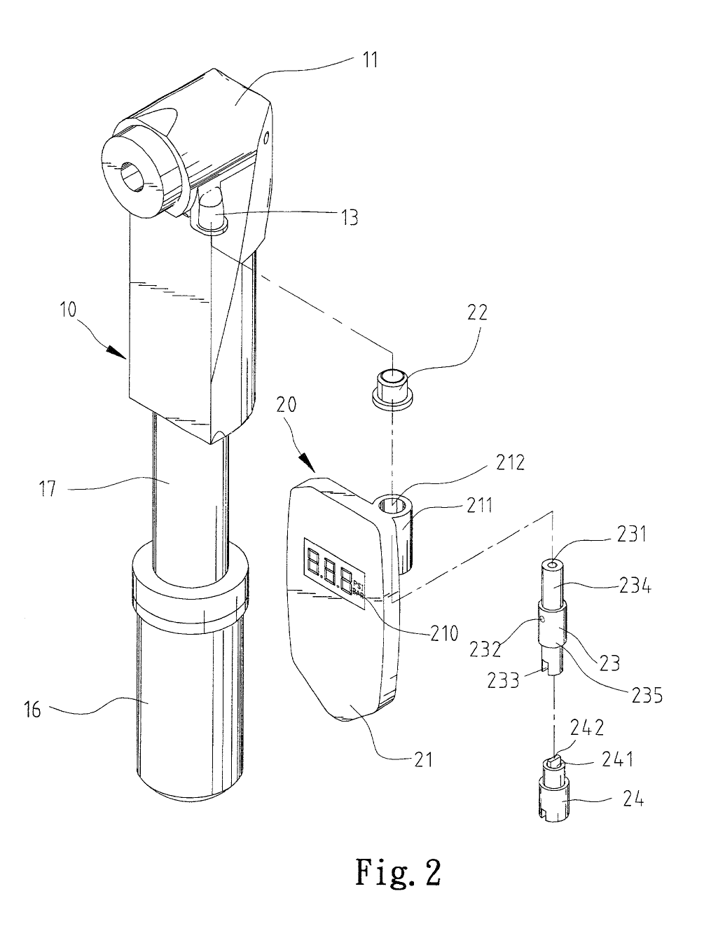

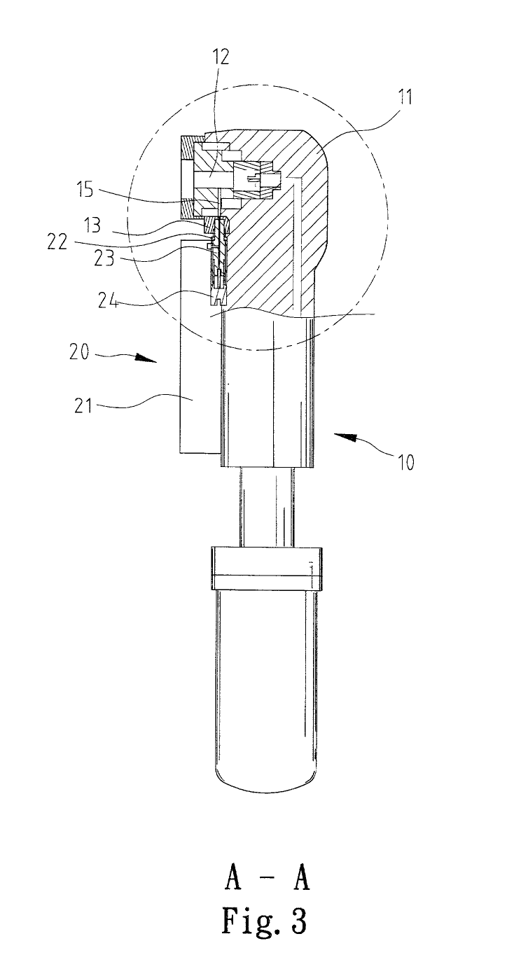

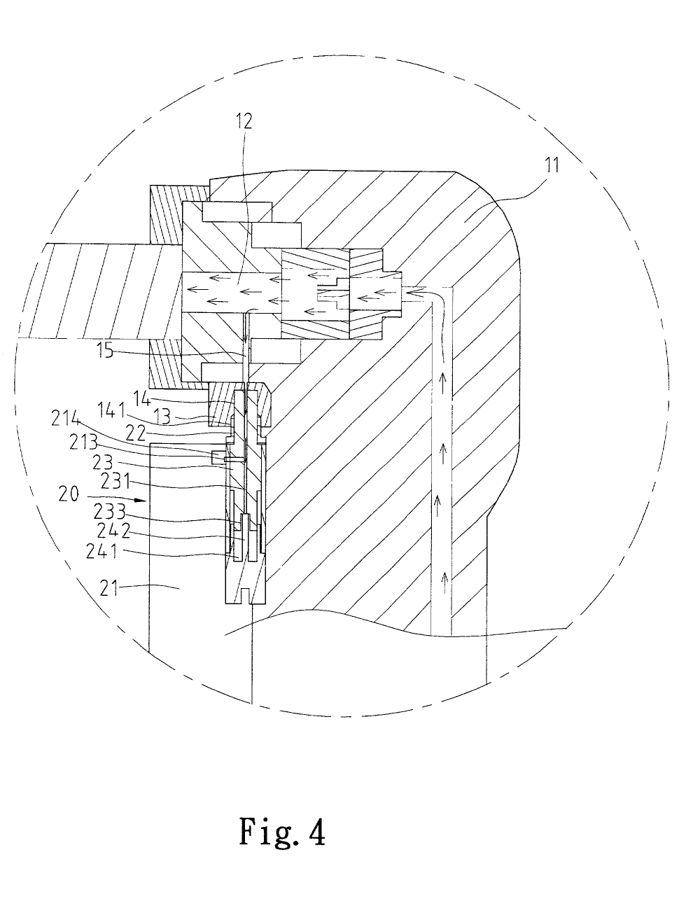

Referring to FIGS. 1 through 3, a hand pump 10 in accordance with the present invention generally includes a cylinder head 11 through which air is outputted upon reciprocating movement of a piston rod 17 that is securely attached to a handle 16 for manual operation. The cylinder head 11 includes an air passage 12 through which air is outputted for inflating an object (e.g., a tire of a bicycle, motorcycle, etc.) to be inflated. The cylinder head 11 further includes a receptacle 14 that is communicated with the air passage 12 via a passage 15. As illustrated in FIG. 4, the receptacle 14 includes a shoulder portion 141.

A pressure gauge 20 is detachably mounted to the hand pump 10 and comprises a main body 21, a tubular engaging member 22, a seat 23, and an end plug 24. The main body 21 includes a display 210 for displaying the pressure of, e.g., a tire. The main body 21 further comprises a tubular member 211 formed on a side thereof, the tubular member 211 having a longitudinal hole 212 and a transverse hole 213 (FIG. 4) communicated with a pressure-sensing means 214 in the main body 21. The seat 23 includes a first portion 234, a second portion 235, and a longitudinal air passage 231 extending through the first portion 234 and the second portion 235. Referring to FIG. 4, the tubular engaging member 22 is releasably engaged in the shoulder portion 141 of the receptacle 14 of the cylinder head 11 and the first portion 234 of the seat 23 is fittingly extended through the engaging member 22 and into the receptacle 14 while the lower portion 234 of the seat 23 is pivotally received in the longitudinal hole 212 of the tubular member 211. The end plug 24 includes a rib 242 on an end 241 thereof for engaging with a cutout 233 in the lower portion 235, thereby sealing the lower end of the longitudinal hole 231 of the seat 23. Thus, the pressure-sensing means 214 is communicated with the air passage 12 via the transverse hole 232 and the longitudinal hole 231 of the seat 23 and the passage 15 in the cylinder head 11, best shown in FIG. 4. As a result, the tire pressure is displayed by the display 210 during inflation. It is noted that the arrangement of the longitudinal hole 231 and the transverse hole 232 can be replaced by other inner passage arrangement that intercommunicates the pressure-sensing means with the air passage 12 of the cylinder head 11.

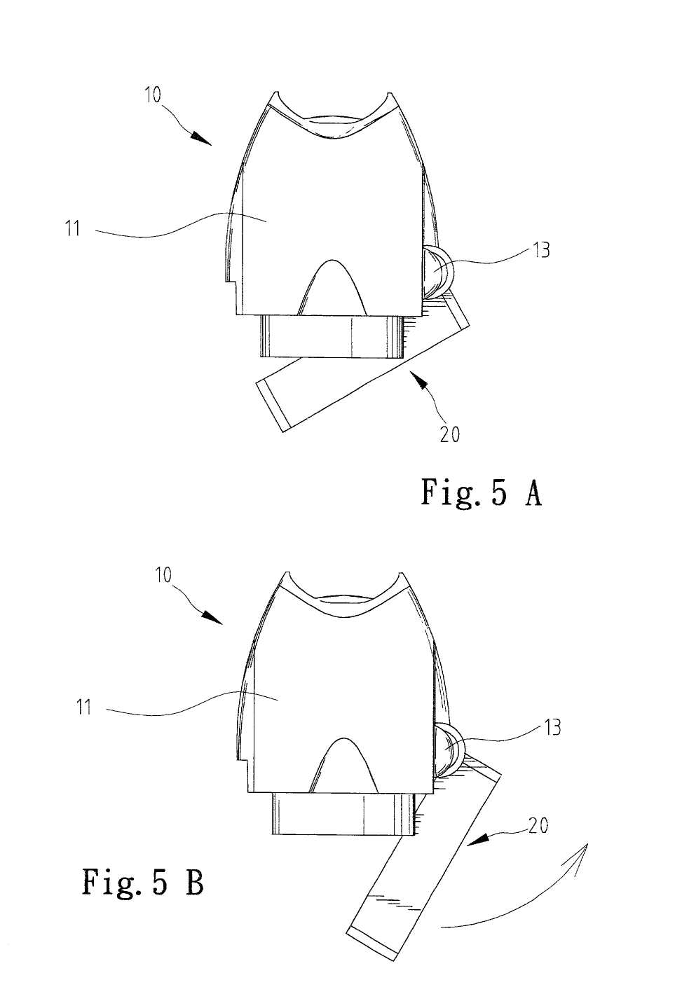

The main body 21 of the pressure gauge 20 can be pivoted to any orientation with respect to the cylinder head 11, thereby providing the user with convenient reading, best shown in FIGS. 5A and 5B.

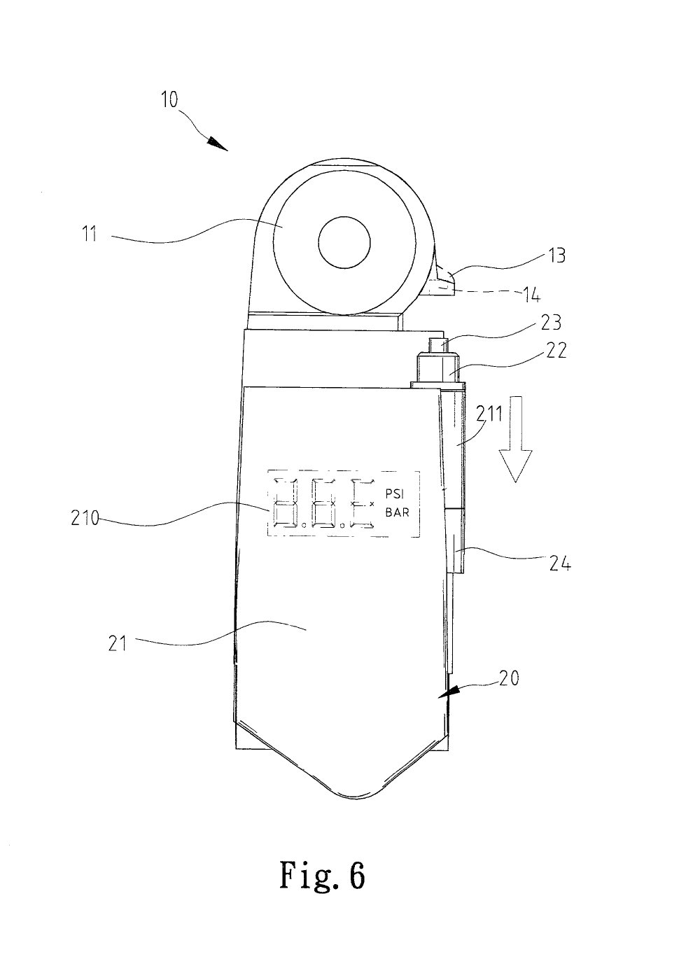

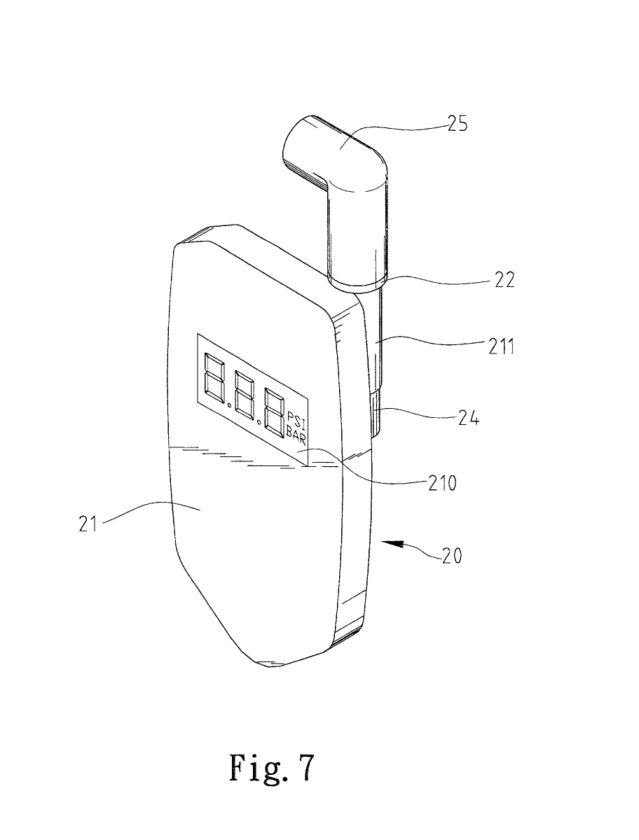

FIG. 6 illustrates detachment of the pressure gauge 20 from the cylinder head 11. It is easily achieved by disengaging the engaging member 22 from the receptacle 14 of the cylinder head 11. Referring to FIG. 7, a coupler 25 configured to suit various tire valves can then be engaged with the engaging member 22 for measuring tire pressure.

Although the invention has been explained in relation to its preferred embodiment, it is to be understood that many other possible modifications and variations can be made without departing from the scope of the invention as hereinafter claimed.

What is claimed is:

1. A hand pump comprising:
a cylinder head comprising an air passage for inflating an object to be inflated, the cylinder head further comprising a receptacle communicated with the air passage; and
a pressure gauge detachably engaged with the receptacle of the cylinder head.

2. The hand pump as claimed in claim 1, wherein the pressure gauge comprises:
a main body including a pressure-sensing means therein and a tubular member formed on a side thereof, the main body further including a display for displaying a pressure value detected by the pressure-sensing means; and
a seat including a first portion securely yet detachably engaged in the receptacle of the cylinder head and a second portion received in the tubular member, the seat including an inner passage intercommunicating the pressure-sensing means with the air passage of the cylinder head.

3. The hand pump as claimed in claim 2, wherein the inner passage of the seat comprises a longitudinal hole having an end communicated with the air passage of the cylinder head and a transverse hole that intercommunicates with the pressure-sensing means with the longitudinal hole of the seat.

4. The hand pump as claimed in claim 3, further comprising an end plug engaged with the second portion of the seat for sealing another end of the longitudinal hole of the seat.

5. The hand pump as claimed in claim 2, wherein the receptacle comprises a shoulder portion, further comprising a tubular engaging member securely yet releasably engaged in the shoulder portion, the first portion of the seat being extending through the tubular engaging member and into the receptacle.

6. A hand pump comprising:
a cylinder head comprising an air passage for inflating an object to be inflated, the cylinder head further comprising a receptacle communicated with the air passage; and
a pressure gauge pivotally engaged with the receptacle of the cylinder head.

7. The hand pump as claimed in claim 6, wherein the pressure gauge comprises:
a main body including a pressure-sensing means therein and a tubular member formed on a side thereof, the main body further including a display for displaying a pressure value detected by the pressure-sensing means; and
a seat including a first portion securely yet detachably engaged in the receptacle of the cylinder head and a second portion received in the tubular member, the seat including an inner passage intercommunicating the pressure-sensing means with the air passage of the cylinder head.

8. The hand pump as claimed in claim 7, wherein the inner passage of the seat comprises a longitudinal hole having an end communicated with the air passage of the cylinder head and a transverse hole that intercommunicates with the pressure-sensing means with the longitudinal hole of the seat.

9. The hand pump as claimed in claim 8, further comprising an end plug engaged with the second portion of the seat for sealing another end of the longitudinal hole of the seat.

10. The hand pump as claimed in claim 8, wherein the receptacle comprises a shoulder portion, further comprising a tubular engaging member securely yet releasably engaged in the shoulder portion, the first portion of the seat being extending through the tubular engaging member and into the receptacle.

11. A pressure gauge detachably mounted to a hand pump for independent use.

12. The pressure gauge as claimed in claim 11, wherein the pressure gauge comprises:
a main body including a pressure-sensing means therein and a tubular member formed on a side thereof, the main body further including a display for displaying a pressure value detected by the pressure-sensing means; and
a seat including a first portion securely yet detachably engaged with a hand pump and a second portion received in the tubular member, the seat including an inner passage intercommunicating the pressure-sensing means with an air passage of the hand pump.

13. The pressure gauge as claimed in claim 12, wherein the inner passage of the seat comprises a longitudinal hole having an end communicated with the air passage of the hand pump and a transverse hole that intercommunicates with the pressure-sensing means with the longitudinal hole of the seat.

14. The pressure gauge as claimed in claim 13, further comprising an end plug engaged with the second portion of the seat for sealing another end of the longitudinal hole of the seat.

15. The pressure gauge as claimed in claim 13, wherein the hand pump comprises a receptacle communicated with the air passage, the receptacle comprising a shoulder portion, further comprising a tubular engaging member securely yet releasably engaged in the shoulder portion, the first portion of the seat being extending through the tubular engaging member and into the receptacle.

16. The pressure gauge as claimed in claim 12, further comprising a coupler releasably engaged with the first portion of the seat, the coupler being adapted to engage with a tire valve.
